(19) United States
(12) Patent Application Publication
(10) Pub. No.: US 2003/0112827 A1
(43) Pub. Date: Jun. 19, 2003

(54) Method and apparatus for deskewing parallel serial data channels using asynchronous elastic buffers

(75) Inventors: Susan Marie Cox, Rochester, MN (US); Mark Joseph Hickey, Rochester, MN (US); Jack Chris Randolph, Rochester, MN (US); Dale John Thomforde, Pine Island, MN (US); Frederick Jacob Ziegler, Rochester, MN (US)

Correspondence Address: Valerie G. Dugan, Dugan & Dugan, L.L.P., 18 John Street, Tarrytown, NY, 10591, US

(73) Assignee: International Business Machines Corporation, Armonk, NY

(21) Appl. No.: 10/022,139

(22) Filed: Dec. 13, 2001

(51) Int. Cl. H04J 3/06

(52) U.S. Cl. 370/509; 370/512

(57) ABSTRACT

A method of deskewing parallel data streams includes receiving the plurality of data streams and storing each of the received data streams in a respective buffer. Synchronization signals in the data streams are detected, and the buffers are controlled to read out the stored data streams on the basis of the detected synchronization signals. Numerous other methods and apparatus are provided.

### FIELD OF THE INVENTION

The present invention is concerned with data communication and is more particularly directed to a data communication link in which plural data streams are transmitted in parallel.

### BACKGROUND OF THE INVENTION

It is known to provide two or more data channels between a pair of computers or other devices capable of data communication (e.g., transmitting plural data streams in parallel). One problem that may be encountered in such an arrangement is skew, i.e., a lack of synchronization between the data arriving on the plural data channels. Prior art approaches to deskewing parallel data channels have involved costly custom delay circuits or special clocks which operate at two or three times the operating frequency of the circuitry employing the parallel data channels. Alternatively, known deskewing approaches have involved complicated skew calculations and handshaking methods. U.S. Pat. Nos. 5,455,831 and 6,031,847 disclose examples of prior art deskewing techniques.

### SUMMARY OF THE INVENTION

According to an aspect of the invention, a first method of deskewing parallel data streams is provided. The method includes receiving a plurality of data streams, storing each of the received data streams in a respective buffer, detecting synchronization signals in the data streams, and controlling the buffers to read out the stored data streams on the basis of the detected synchronization signals.

According to another aspect of the invention, a second method of deskewing parallel data streams is provided. The method in accordance with this aspect of the invention includes receiving a plurality of data streams, storing each of the received data streams in a respective buffer, comparing respective timings of the received data streams, and controlling read pointers of the buffers on the basis of a result of the comparing step.

According to still another aspect of the invention, an apparatus for deskewing parallel data streams is provided. The apparatus includes a first port for receiving a first data stream, a second port for receiving a second data stream, a first buffer coupled to the first port for storing the received first data stream, and a second buffer coupled to the second port for storing the received second data stream. The apparatus further includes a deskew circuit coupled to the first and second buffers and operative to detect synchronization signals in the first and second data streams, and to control the first and second buffers to read out the stored first and second data streams on the basis of the detected synchronization signals.

According to a further aspect of the invention, an apparatus for deskewing parallel data streams includes a first port for receiving a first data stream, a second port for receiving a second data stream, a first buffer coupled to the first port for storing the received first data stream, and a second buffer coupled to the second port for storing the received second data stream. The apparatus further includes a deskew circuit coupled to the first and second buffers and operative to compare respective timings of the received first and second data streams and to control read pointers of the buffers on the basis of a result of the comparison of the respective timings of the received first and second data streams.

According to still a further aspect of the invention, a method of deskewing parallel data streams includes providing a pair of buffers, each for storing a respective one of the data streams, reading out respective signals from at least one of the pair of buffers, determining that one of the signals read out from one of the buffers is a synchronization signal, and, responsive to the determining step, holding a read pointer of the one of the buffers from which the synchronization signal was read out until a synchronization signal is read out from the other one of the buffers.

According to yet another aspect of the invention, an apparatus for deskewing parallel data streams includes a first port for receiving a first data stream, a second port for receiving a second data stream, a first buffer coupled to the first port for storing the received first data stream, and a second buffer coupled to the second port for storing the received second data stream. The apparatus further includes a deskew circuit coupled to the first and second buffers and operative to read out respective signals from at least one of the first and second buffers, make a determination that one of the signals read out from one of the buffers is a synchronization signal, and respond to the determination by holding a read pointer of the one of the buffers from which the synchronization signal was read out until a synchronization signal is read out from the other one of the buffers.

As used herein and in the appended claims, a “synchronization signal” may include any signal included in a data stream to indicate a timing of the data stream.

The deskewing apparatus and methods of the present invention are simple and inexpensive, and may be implemented using off-the-shelf hardware.

Other objects, features and advantages of the present invention will become more fully apparent from the following detailed description of exemplary embodiments, the appended claims and the accompanying drawings.

### BRIEF DESCRIPTION OF THE DRAWINGS

FIG. 1 is a block diagram of a data communication receiving apparatus that includes deskewing logic provided in accordance with the present invention;

FIG. 2 is a flow chart that illustrates operation of the deskewing logic included in the apparatus of FIG. 1;

FIG. 3 is a schematic representation of FIFO (first-in-first-out) buffer memories controlled by the deskewing logic of FIG. 1 in accordance with the invention; and

FIGS. 4-6 are schematic timing diagrams that illustrate examples of signal skew corrected by the deskewing logic of the present invention.

### DETAILED DESCRIPTION

The assignee of the present application has proposed a data communication link in which a precursor data stream is divided into first and second data streams to be respectively transmitted in serial form over parallel optical fibers. The purpose of this proposed link is to replace prior art parallel data links formed of metal connectors which have a maximum range of about 15 meters. By contrast, the parallel, serial (optical fiber) data link now proposed has a range of up to about 500 meters. In the proposed data communication link, each 32 bit word of the precursor data stream is divided into half words. The first data stream to be transmitted over one of the optical fibers is composed of first half-words of the precursor data stream. The second data stream to be transmitted over the other one of the optical fibers is composed of second half-words of the precursor data stream. Advantageous transmission characteristics are obtained by encoding each 8 bit byte of the data in accordance with an 8 bit/10 bit (8 b/10 b) encoding scheme provided in the well-known Fibre Channel data communications standard (e.g., ANSI X3.230-1994-FC-PH Fibre Channel Standards). While the present invention will be described primarily with reference to the proposed data communication link, it will be understood that the invention may be employed within other data communication links, employing more than two parallel data streams, using other coding formats than those described herein, or the like, as described further below.

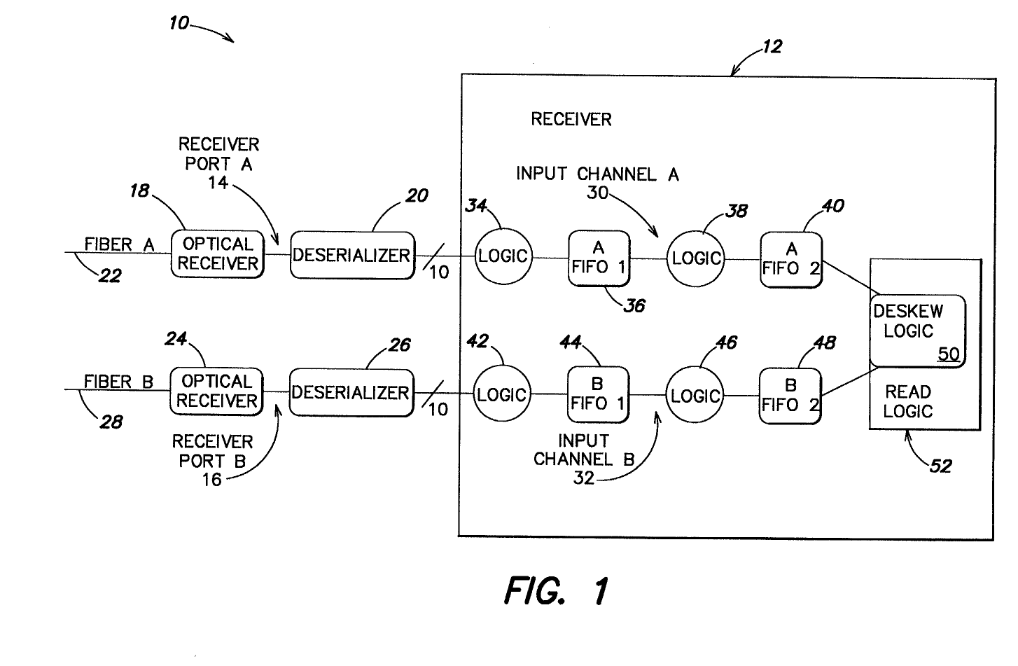

FIG. 1 is a block diagram of a receiver apparatus provided in accordance with the invention for the proposed data communication link. Reference numeral 10 generally indicates the receiver apparatus. The receiver apparatus 10 includes a receiver circuit 12, which is coupled to a first receiver port 14 (receiver port A) and a second receiver port 16 (receiver port B). The first receiver port 14 includes a first optical receiver 18 and a first deserializer circuit 20 coupled to the first optical receiver 18. The first optical receiver 18 is coupled to a first optical fiber 22 (fiber A) to receive a first data stream transmitted via the first optical fiber 22.

The second receiver port 16 includes a second optical receiver 24 and a second deserializer circuit 26 coupled to the second optical receiver 24. The second optical receiver 24 is coupled to a second optical fiber 28 (fiber B) to receive a second data stream transmitted via the second optical fiber 28.

Each of the deserializer circuits 20, 26, the optical receivers 18, 24 and the optical fibers 22, 28 may operate in accordance with conventional principles. For example, the deserializer circuits 20, 26 may each be constituted by a respective conventional serializer/deserializer (serdes) such as the Agilent model number HDMP2631. (It will be recognized that FIG. 1 may represent one direction of a two-way data link.) In operation, the first optical receiver 18 converts the serial optical signal transmitted via the first optical fiber 22 into a serial electrical signal. The first deserializer circuit 20 recovers a clock signal from the serial electrical signal output from the first optical receiver 18 and outputs 10-bit data bytes. Similarly, the second optical receiver 24 converts the serial optical signal transmitted via the second optical fiber 28 into a serial electrical signal. The second deserializer circuit 26 recovers a clock signal from the serial electrical signal output from the second optical receiver 24 and outputs 10-bit data bytes.

The receiver circuit 12 is coupled to the first deserializer circuit 20 of the first receiver port 14, and is also coupled to the second deserializer circuit 26 of the second receiver port 16. The 10-bit bytes output from the first deserializer circuit 20 are received by the receiver circuit 12 in a first input channel 30 (input channel A). The 10-bit bytes output from the second deserializer circuit 26 are received by the receiver circuit 12 in a second input channel 32 (input channel B).

The first input channel 30 includes, in sequence, a first logic circuit 34, a first FIFO buffer 36 (A FIFO 1), a second logic circuit 38 and a second FIFO buffer 40 (A FIFO 2).

The second input channel 32 includes, in sequence, a third logic circuit 42, a third FIFO buffer 44 (B FIFO 1), a fourth logic circuit 46, and a fourth FIFO buffer 48 (B FIFO 2). The FIFO buffers 36, 40, 44 and 48 may comprise any conventional FIFO buffer, such as a conventional FIFO software macro, provided, for example, by Xilinx, Inc.

The first and second input channels 30, 32 are substantially identical to each other, and operate in a substantially identical fashion, so that only the first input channel 30 will be further described. The first logic circuit 34 of the first input channel 30 manages writing of data into the first FIFO buffer 36 and determines when it is appropriate to drop idle half-words that may be present in the data stream input via the first input channel 30. The first logic circuit 34 also performs some error detection functions.

The first FIFO buffer 36 passes data from one clock domain to another. For example, one clock (not shown) may drive logic that controls the write side of the first FIFO buffer 36 and the state machine (included in the first logic circuit 34) on the write side of the FIFO buffer 36, and a second clock (not shown) may drive logic that controls the read side of the FIFO buffer 36 and the state machine (included in the second logic circuit 38) on the read side of the FIFO buffer 36. These clocks (not shown) may have the same or different frequencies and/or phases. The second logic circuit 38 also performs 10-bit/8-bit decoding. The second logic circuit 38 also manages writing of data into the second FIFO buffer 40.

The second FIFO buffer 40, like the fourth FIFO buffer 48, is coupled to a deskew logic circuit 50, which is part of a read logic circuit 52 of the receiver circuit 12. The second FIFO buffer 40 and the fourth FIFO buffer 48 hold data for deskewing by the deskew logic circuit 50 and for reading by the read logic circuit 52. Skew between the respective data streams received via the first and second input channels 30 and 32 may arise from a number of causes, including differences in length between the first and second optical fibers 22, 28; variations between other channel components (e.g., due to transmitter, receiver, serializer, deserializer, optical connector, electrical connector, patch panel, on-card wiring, etc., variations); and clock tolerances.

The second FIFO buffer 40 and the fourth FIFO buffer 48 both operate as asynchronous elastic buffers. That is, different clock signals are used for writing to and reading from each buffer, and the amount of delay between writing and reading is variable in these two buffers.

In one embodiment of the invention, deskewing is performed by the deskew logic 50 only if a skew condition or other error condition is detected by the deskew logic 50. In other embodiments, deskewing always may be performed. To set the stage for deskewing, the second and fourth FIFO buffers 40 and 48 are cleared, and the second logic circuit 38 and the fourth logic circuit 46 are operated so as to ignore (not write into the second and fourth FIFO buffers 40 and 48) any signals other than training sequences.

Training sequences are sequences of signals that are provided intermittently in the data streams transmitted via the first and second optical fibers 22 and 28. The training sequences may appear in the data streams at regular or irregular intervals of about 8 to 32 microseconds, for example. In one embodiment of the invention, each training sequence is made up of four iterations of a sequence composed of a synchronization character (comma-sync) followed by a minimum of five fill characters (comma-fill). In one embodiment of the invention, the synchronization character is either “comma-sync even” (“001111_{—}1010” followed by “001001_{—}1001”) or “comma-sync odd” (“001111_{—}1010” followed by “001001_{—}0101”), depending on the data stream. According to an invention disclosed in co-pending application Ser. No. ______, filed ______ (Attorney Docket No. ROC920010225US1), the “comma-sync even” and “comma-sync odd” characters are inserted at a transmitter (not shown) coupled to the fibers 22, 28 to respectively identify the two data streams so that the receiver circuit 12 can automatically configure itself during connection of either fiber 22, 28 to either receiver port 14, 16. This co-pending patent application is incorporated herein by reference in its entirety. Any other suitable training sequence may be similarly employed.

Exemplary error detection (including synchronization error detection), handshaking and initialization functions that may be performed by the read logic circuit 52, the second logic circuit 38 and the fourth logic circuit 46 are disclosed in co-pending patent application Ser. No. ______, filed ______ (Attorney Docket No. ROC920010282). This co-pending patent application is incorporated herein by reference in its entirety.

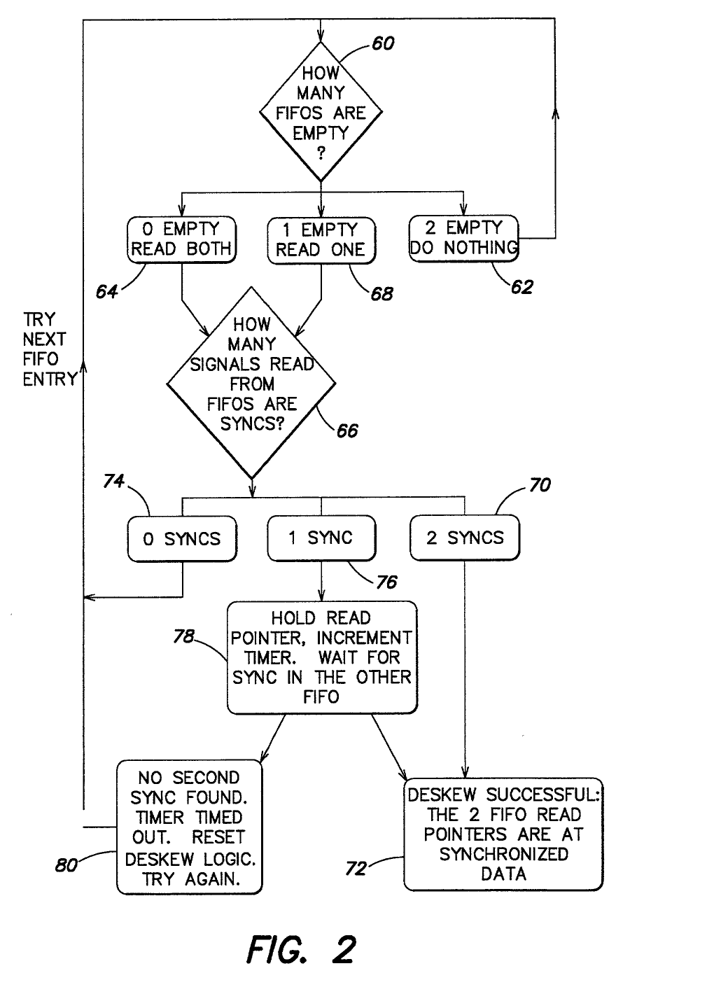

FIG. 2 is a flow chart that illustrates a deskewing procedure that may be carried out in accordance with the present invention by the deskew logic circuit 50 of FIG. 1. At a first block 60 in FIG. 2, which is a decision block, the deskew logic circuit 50 determines if the second FIFO buffer 40 and the fourth FIFO buffer 48 are empty. This determination may be made based on “empty” signals provided to the deskew logic circuit 50 in accordance with conventional practice by the FIFO buffers 40, 48 when the buffers 40, 48 are empty. If both of the FIFO buffers 40, 48 are empty, as indicated at block 62, then the procedure of FIG. 2 returns to decision block 60 to operate at a next cycle of the deskew logic circuit 50. If neither one of the second FIFO buffer 40 and the fourth FIFO buffer 48 is empty, as indicated at block 64, then both of the second and fourth FIFO buffers 40, 48 are read by reading signals (e.g., data, synchronization, etc.) from the buffers 40, 48 identified by a read pointer associated with each FIFO buffer 40, 48; and decision block 66 follows. The use of read pointers when reading FIFO buffers is well known in the art and is not described further herein. If only one of the second FIFO buffer 40 and the fourth FIFO buffer 48 is empty, as indicated at block 68, then the buffer which is not empty is read, and decision block 66 follows.

At decision block 66, the deskew logic circuit 50 determines how many of the signals read at block 64 or block 68, as the case may be, are sync signals (e.g., the above-referenced synchronization characters). If a sync signal was read from both of the second FIFO buffer 40 and the fourth FIFO buffer 48, as indicated at block 70 (which cannot occur if decision block 66 was reached from block 68), then no deskewing is necessary, because the two data streams are already synchronized. Accordingly, the procedure of FIG. 2 reaches a successful conclusion at block 72 following block 70.

On the other hand, if none of the signals read at blocks 64 or 68, as the case may be, was a sync signal, as indicated at block 74, then the procedure of FIG. 2 returns to decision block 60 for the next cycle of the deskew logic circuit 50.

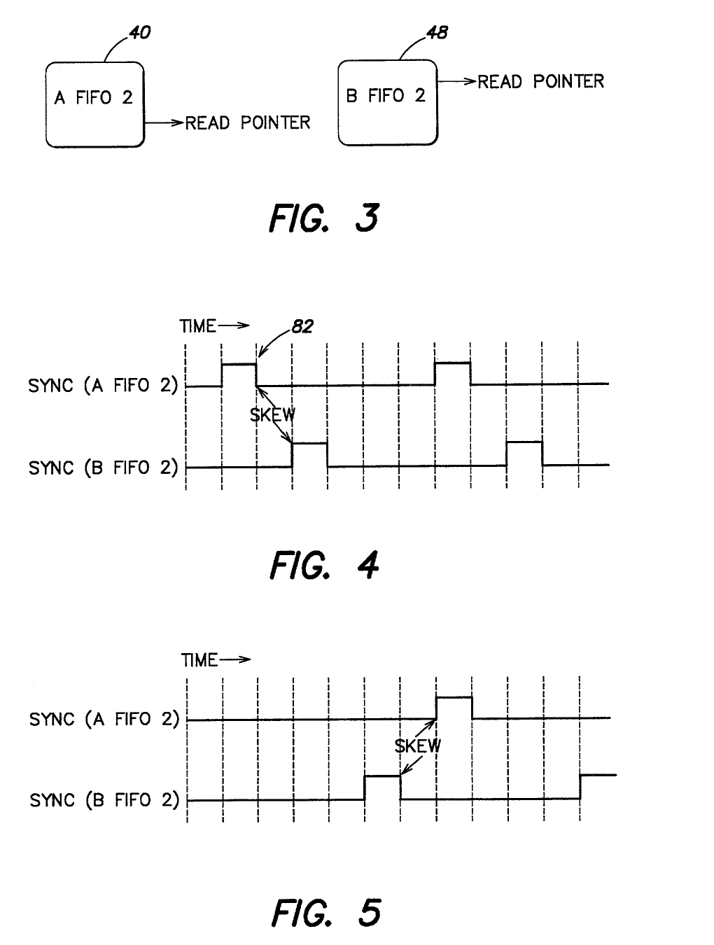

The remaining possibility, indicated by block 76, is that one but not both of the signals read at block 64 was a sync signal, or that the one signal read at block 68 was a sync signal. In this circumstance, block 78 follows. At block 78, the read pointer is held for the one of the second FIFO buffer 40 and the fourth FIFO buffer 48 from which the sync signal was read (i.e., the synced buffer). Succeeding entries in the other of the second FIFO buffer 40 and the fourth FIFO buffer 48 (i.e., the unsynced buffer) are read to determine whether a sync signal is found in the other input channel (either input channel 30 or 32 as the case may be). A timer or counter (not shown) may be employed to monitor the length of time or the number of times the unsynced buffer is read. If the sync signal appears in the other input channel (i.e., in the other one of the second FIFO buffer 40 and the fourth FIFO buffer 48 for which a sync signal was not previously read (the unsynced buffer)), then deskewing has been accomplished, since both the read pointers for the second FIFO buffer 40 and the fourth FIFO buffer 48 now point to sync signals. In this case block 72 follows block 78. The data following the sync signals in the two FIFO buffers 40 and 48 are synchronized by virtue of the offset in the read pointers for the respective FIFO buffers, as schematically illustrated in FIG. 3. The read logic circuit 52 is now able to read synchronized data from the second and fourth FIFO buffers 40, 48. It will be appreciated that the second and fourth FIFO buffers 40, 48 continue to store incoming data as the deskew logic circuit 50 operates, and have sufficient storage capacity to accommodate the delay entailed in the deskew operation.

If at block 78 the second sync signal is not received before the timer (not shown) times out (or the counter (not shown) reaches a predetermined value), then block 80 follows block 78. At block 80 the deskew logic circuit 50 is reset and the procedure of FIG. 2 returns to decision block 60 for another attempt at deskewing. The time-out time for the timer (not shown) may be based on, for example, the maximum acceptable signal skew between the channels 30, 32 (e.g., based on the anticipated timing differences due to physical differences between the two channels such as differences in fiber length).

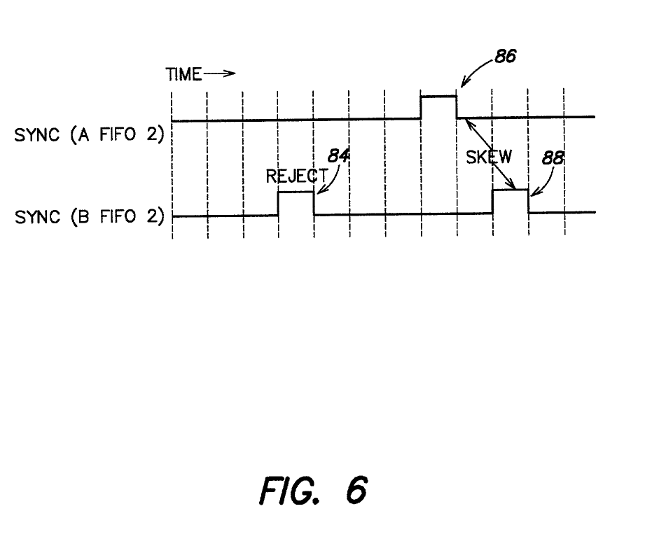

FIGS. 4-6 are timing diagrams that illustrate various situations that the deskew logic circuit 50 of FIG. 1 may encounter. In FIGS. 4-6 the pulses are indicative of sync signals received in the respective input channels 30, 32, i.e., stored in the second FIFO buffer 40 (A FIFO 2) and in the fourth FIFO buffer 48 (B FIFO 2).

In the situation represented by FIG. 4, there is skew between the two data streams in that the data stream received in the second input channel 32 (channel B) lags the data stream received in the first input channel 30 (channel A) by two clock cycles. Deskewing is performed in this case, in accordance with block 78 of FIG. 2, by holding the read pointer for the second FIFO buffer 40 (A FIFO 2) for two clock cycles until the matching sync signal is read out by the deskew logic circuit 50 from the fourth FIFO buffer 48 (B FIFO 2).

In the situation represented by FIG. 5, there is skew between the two data streams, in that the data stream received in the first input channel 30 (channel A) lags the data stream received in the second input channel 32 (channel B) by two clock cycles. Deskewing is performed in this situation, in accordance with block 78 of FIG. 2, by holding the read pointer for the fourth FIFO buffer 48 (B FIFO 2) for two clock cycles until the matching sync signal is read out by the deskew logic circuit 50 from the second FIFO buffer 40 (A FIFO 2).

FIG. 6 represents a variation on the situation of FIG. 4, in which a first sync signal (corresponding to the pulse indicated at 82 in FIG. 4) that should have been received on channel A, was suppressed, as may occur due to a clock alignment process carried on in the deserializer circuit (the first deserializer circuit 20, in this case). Continuing to refer to FIG. 6, the sync signal in channel B as indicated at 84, which would have matched with the sync signal that was suppressed in channel A, is rejected in accordance with block 80 of FIG. 2, because the timer (not shown) initiated in block 78 has timed out. Deskewing is subsequently performed with respect to the matching sync signals indicated at 86 and 88 in FIG. 6.

In one embodiment of the invention the deskew logic circuit 50 is arranged to deal with up to two cycles of skew between the respective data streams, as it is considered unlikely that a greater amount of skew will be encountered assuming the maximum length difference between the fibers 22 and 28 is about 2 meters or less and the potential contributions by other possible sources of skew in the above-described data link. It will be observed that the minimum of five comma-fill characters which follow each comma-sync character in the training sequence accommodate the exemplary capacity of deskewing up to a two-cycle degree of skew. It is contemplated, however, to arrange the deskew logic circuit 50 to be capable of deskewing only a one-cycle degree of skew, or to be capable of deskewing degrees of skew in excess of two cycles. If deskewing degrees of skew in excess of two cycles is to be provided, then the minimum number of comma-fill characters after each comma-sync character should be increased from five.

In one embodiment of the invention, the receiver circuit 12 shown in FIG. 1 is part of a transceiver (not shown) that is implemented by programming a conventional programmable logic device (PLD) such as the Xilinx XCV300E-8FG456C. The procedure illustrated in FIG. 2 may be implemented in hardware, software or a combination thereof, but in the embodiment of the invention just referred to, is implemented by programming the above-mentioned PLD. The programming of a PLD to perform the procedure of FIG. 2 is well within the abilities of those of ordinary skill in the art. It is alternatively contemplated to implement the present invention with a suitably programmed general purpose processor, by an application specific integrated circuit (ASIC) and/or by a circuit made up of discrete components or by a combination of such means. In a software embodiment of the invention, the procedure of FIG. 2 may comprise one or more computer program products. Each inventive computer program product may be carried by a medium readable by a computer (e.g., a carrier wave signal, a floppy disk, a hard drive, a random access memory, etc.).

By implementing deskew logic, as well as the buffers controlled by the deskew logic, as part of an off-the-shelf, programmable device, a solution to skew between the parallel data streams is provided that is simple and inexpensive.

The foregoing description discloses only exemplary embodiments of the invention; modifications of the above disclosed apparatus and method which fall within the scope of the invention will be readily apparent to those of ordinary skill in the art. For example, although the above exemplary embodiment discloses deskewing two parallel data streams, it is contemplated to apply the present invention to deskewing three or more parallel data streams (e.g., by duplicating the components of an existing channel in each additional channel). Also, it is contemplated to employ additional sets of FIFOs in each channel, or only one set of FIFOs in each channel.

Furthermore, although the synchronization signal used for deskewing in the present invention was represented by a comma-sync signal in a 10-bit code encoded in accordance with 8-bit/10-bit encoding, it is also contemplated to apply the present invention using sync signals in other formats.

Still further, the present invention has been illustrated in connection with an example in which parallel data streams are derived from a precursor data stream by transmitting in a first one of the data streams first half-words of the precursor data stream, and transmitting in the other one of the data streams second half-words of the precursor data stream. However, it is contemplated to apply the present invention to data streams that are derived in other fashions from a precursor data stream.

In the exemplary embodiments disclosed herein the data streams are transmitted in respective data channels that include optical fibers. However, it is also contemplated to apply the present invention in data links that employ metal conductors, such as wires, metal traces, or coaxial cables, to transmit data signals in electrical form.

In the above-described embodiments, each data stream is transmitted in serial form, but it is also contemplated to employ the present invention where each data stream is transmitted in a parallel format.

In the above-described embodiments, the data streams are encoded for transmission according to the 8 b/10 b code. Other transmission formats are contemplated.

Accordingly, while the present invention has been disclosed in connection with exemplary embodiments thereof, it should be understood that other embodiments may fall within the spirit and scope of the invention, as defined by the following claims.

The invention claimed is:

1. A method of deskewing parallel data streams, comprising:
receiving a plurality of data streams;
storing each of the received data streams in a respective buffer;
detecting synchronization signals in the data streams; and
controlling the buffers to read out the stored data streams on the basis of the detected synchronization signals.

2. The method of claim 1, wherein the plurality of data streams consists of two data streams.

3. The method of claim 1, wherein the detecting step includes reading synchronization signals in the data streams stored in the buffers.

4. The method of claim 1, wherein the controlling step includes controlling respective read pointers of the buffers to simultaneously point at synchronization signals stored in the buffers.

5. The method of claim 1, wherein each of the data streams is received via a respective receiver port.

6. The method of claim 5, wherein each of the data streams is received via a respective optical fiber.

7. A method of deskewing parallel data streams, comprising:
receiving a plurality of data streams;
storing each of the received data streams in a respective buffer;
comparing respective timings of the received data streams; and
controlling read pointers of the buffers on the basis of a result of the comparing step.

8. The method of claim 7, wherein the comparing step includes reading synchronization signals from the data streams stored in the buffers.

9. The method of claim 7, wherein the plurality of data streams consists of two data streams.

10. The method of claim 7, wherein each of the data streams is received via a respective receiver port.

11. The method of claim 7, wherein each of the data streams is received via a respective optical fiber.

12. The method of claim 7, wherein the controlling step includes controlling respective read pointers of the buffers to simultaneously point at synchronization signals stored in the buffers.

13. An apparatus adapted to deskew parallel data streams, comprising:
a first port adapted to receive a first data stream;
a second port adapted to receive a second data stream;
a first buffer coupled to the first port and adapted to store the received first data stream;
a second buffer coupled to the second port and adapted to store the received second data stream; and
a deskew circuit coupled to the first and second buffers and operative to:
detect synchronization signals in the first and second data streams; and
control the first and second buffers to read out the stored first and second data streams on the basis of the detected synchronization signals.

14. The apparatus of claim 13, wherein the deskew circuit detects the synchronization signals by reading the synchronization signals in the first and second data streams respectively stored in the first and second buffers.

15. The apparatus of claim 13, wherein the first buffer, the second buffer and the deskew circuit are implemented in a programmable logic device or an application specific integrated circuit.

16. The apparatus of claim 13, wherein the first port is coupled to a first optical fiber and the second port is coupled to a second optical fiber.

17. The apparatus of claim 13, wherein the deskew circuit controls respective read pointers of the first and second buffers to simultaneously point at synchronization signals stored in the first and second buffers.

18. An apparatus adapted to deskewing parallel data streams, comprising:
a first port adapted to receive a first data stream;
a second port adapted to receive a second data stream;
a first buffer coupled to the first port and adapted to store the received first data stream;
a second buffer coupled to the second port and adapted to store the received second data stream; and
a deskew circuit coupled to the first and second buffers and operative to:
compare respective timings of the received first and second data streams; and
control read pointers of the buffers on the basis of a result of the comparison of the respective timings of the received first and second data streams.

19. The apparatus of claim 18, wherein the first buffer, the second buffer and the deskew circuit are implemented in a programmable logic device or an application specific integrated circuit.

20. The apparatus of claim 18, wherein the first port is coupled to a first optical fiber and the second port is coupled to a second optical fiber.

21. The apparatus of claim 18, wherein the deskew circuit controls respective read pointers of the first and second buffers to simultaneously point at synchronization signals stored in the first and second buffers.

22. A method of deskewing parallel data streams, comprising:
providing a pair of buffers, each for storing a respective one of the data streams;
reading out respective signals from at least one of the pair of buffers;
determining that one of the signals read out from one of the buffers is a synchronization signal; and
responsive to the determining step, holding a read pointer of the one of the buffers from which the synchronization signal was read out until a synchronization signal is read out from the other one of the buffers.

23. An apparatus for deskewing parallel data streams, comprising:
a first port for receiving a first data stream;
a second port for receiving a second data stream;
a first buffer coupled to the first port for storing the received first data stream;
a second buffer coupled to the second port for storing the received second data stream; and
a deskew circuit coupled to the first and second buffers and operative to:
read out respective signals from at least one of the first and second buffers;
make a determination that one of the signals read out from one of the buffers is a synchronization signal; and
respond to the determination by holding a read pointer of the one of the buffers from which the synchronization signal was read out until a synchronization signal is read out from the other one of the buffers.
